(19) United States
(12) Patent Application Publication
(10) Pub. No.: US 2003/0023530 A1
(43) Pub. Date: Jan. 30, 2003

(54) Method of initiating a sale of a property right application or of a property right

(76) Inventor: Rainer Kuth, Herzogenaurach (DE)

Correspondence Address: YOUNG & THOMPSON, 745 SOUTH 23RD STREET 2ND FLOOR, ARLINGTON, VA, 22202

(21) Appl. No.: 10/188,747

(22) Filed: Jul. 5, 2002

(30) Foreign Application Priority Data
Jul. 6, 2001 (DE) 10132814.1

(51) Int. Cl. G06F 17/60

(52) U.S. Cl. 705/35

(57) ABSTRACT

The invention relates to a method of initiating a sale of a property right application or of a property right by a data processing device (4). For this purpose, the data processing device (4) receives from an offering party (X) a code of a property right application that is for sale or of a property right that is for sale, the property right application or the property right being clearly identifiable by the code. Subsequently, the data processing device (4) identifies a property right application of interest or a property right of interest on the basis of at least one criterion. Alternatively, the data processing device (4) additionally finds a party (K2, K3) potentially interested in buying the property right application or the property right, so that a contact between the offering party (X) or seller (X) and the potential buyer (K2, K3) can be established.

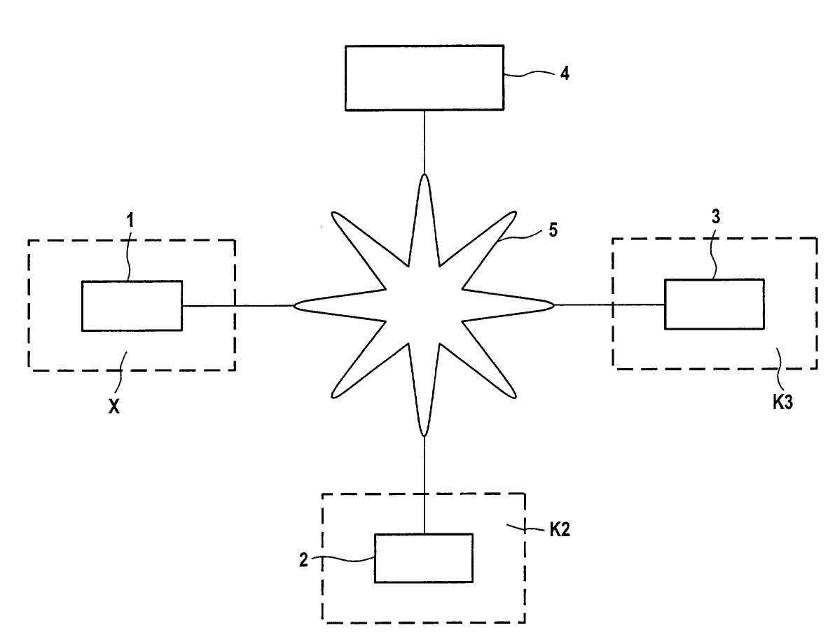

The invention relates to a method of initiating a sale of a property right application or of a property right with the aid of modern means of communication.

Property right applications or industrial property rights represent economic goods which are being increasingly bought and sold like conventional economic goods. Interested in a sale of property right applications or property rights are, for example, companies which would like to give up some of their research activities and convert the portfolio of related property rights into other assets. Furthermore, in cases of company bankruptcies or composition proceedings, there is often the need for property right applications or property rights to be able to be sold quickly and effectively. When selling property right applications or property rights, it proves to be problematical, in particular for those who are not specialists in this area, such as in the case of an administrator in bankruptcy proceedings, to identify potential interested parties at a national or international level. In principle, property right applications or property rights of this type could be given to companies or partnerships exploiting third-party rights, which find suitable potential buyers. However, experience shows that such a method is relatively laborious and expensive.

The invention is therefore based on the object of specifying a method of the type stated at the beginning in such a way as to create the preconditions for being able to sell property right applications or property rights quickly and effectively.

According to the invention, this object is achieved by a method of initiating a sale of a property right application or a property right, having the following method steps:

a) reception by a data processing device of a code, originating from an offering party, of a property right application that is for sale or of a property right that is for sale which allows a clear identification of the property right application or the property right, and

b) identification by the data processing device of a property right application of interest or a property right of interest and/or finding of a party potentially interested in the property right application or the property right on the basis of a criterion.

With the aid of the method according to the invention, a party interested in the purchase of property right applications or property rights can consequently identify property right applications or property rights of interest to it quickly and effectively in an automated manner by a data processing device on the basis of at least one criterion and, if appropriate, can make contact with the offering party for sales negotiations. Alternatively, the method according to the invention can be additionally used to find for an offering party or seller of a property right application or a property right parties potentially interested in the property right application to be sold by the offering party, or the property rights to be sold, quickly and effectively in an automated manner by a data processing device on the basis of at least one criterion. The criterion is in this case preferably specified by the respective potential interested party. Consequently, the criterion can be used not only for identifying a property right application or property right but also for assigning it to a potential interested party. In this case, the offering party need not have any special knowledge of the market situation and can nevertheless quickly detect whether and to what extent a property right application or property right can be sold.

According to one embodiment of the invention, the offering party is automatically notified by the data processing device of found parties potentially interested in a property right application or a property right with the aid of modern means of communication. The offering party or persons acting for the offering party can finally make contact with the potential interested parties for sales negotiations.

According to another embodiment of the invention, the data processing device automatically sends a message to a found potential interested party that the property right application or the property right is for sale. The message may in this case be a request to the interested party to submit an offer to the seller or else actually be an offer of the seller to the potential buyer. In the case of this embodiment of the invention, the buyer itself consequently does not even have to actively approach potential interested parties.

Variants of the invention provide that the property right application is a patent application or the property right is a patent and that the property right application or the property right is allocated to a class, in the case of a patent application or a patent to a patent class. According to one variant of the invention, the fact that the property right application or the property right belongs to a class represents a criterion on the basis of which a property right application or property right is identified and a potential interested party is found. A potential interested party can consequently notify the data processing device, for example, of specific patent classes and consequently show its interest in patents which fall into this patent class.

Other variants of the invention provide that the criterion for the identification of a property right application or property right and the finding of a potential interested party comprises one or more specific headwords or at least one date, for example a filing date or a priority date. Furthermore, the criterion may be a code of a property right application or property right, that is for example an actual patent number. It is also possible in this way for the data processing device to identify specific property right applications or property rights and assign them to a potential interested party in an automated manner, in order to present to this interested party for example an offer to buy the property right application or the property right.

An exemplary embodiment of the invention is represented in the accompanying schematic drawing, which shows a communication structure for performing the method according to the invention.

Represented in the figure are four data processing devices 1 to 4, which are connected to a schematically represented communication network 5 in such a way that the data processing devices 1 to 4 can communicate with one another. The data processing device 1 is assigned to an offering party or a seller of property right applications and property rights. The data processing devices 2 and 3 are respectively assigned to a potential interested party or a potential customer K2 and K3 with respect to property right applications and property rights. The data processing device 4 is assigned to a service provider, which informs potential customers of the sale of property right applications and property rights.

In the case of the present exemplary embodiment, the offering party, to which the data processing device 1 is assigned, is a company X which has gone bankrupt. The administrator in the bankruptcy proceedings for the company X has identified some patents of the company X which it would like to sell. For this purpose, the administrator in the bankruptcy proceedings transmits, as a code of the patents that are for sale, the patent numbers via the communication network 5 to the data processing device 4 of the service provider. The data processing device 4 allocates the patents, which are clearly identifiable on the basis of their patent number, to existing patent classes. In this case, a patent may also be allocated to more than one patent class. The patent classes are patent classes known per se, that is for example IPC classes, US patent classes or else Derwent classes.

Finally, for the selection of potential customers, the data processing device 4 keeps specifications which have been transmitted to the data processing device 4 by the potential customers with respect to property right applications or property rights. In the case of the present exemplary embodiment, specific patent classes of interest to the customer K2 and specific headwords which describe subjects with respect to which the customer K2 is seeking to buy patents were transmitted to the data processing device 4 by the data processing device 2 of the potential customer K2. Furthermore, the customer K2 has transmitted with its data processing device 2 to the data processing device 4 specific numbers of patents which it is interested in buying.

In the same way, the customer K3 has also transmitted to the data processing device 4, via its data processing device 3, patent classes of interest to it, headwords relating to subjects of interest to it and patent numbers.

Once patent numbers of patents to be sold have been transmitted on the part of the data processing device 1 to the data processing device 4, in the case of the present exemplary embodiment the latter checks on the basis of the patent numbers whether there are among them patents in which the customers K2 and K3 are interested. In the case of the present exemplary embodiment, among the patents offered there is a patent in which the customer K2 is interested. After the identification of this patent and the assignment to the customer K2 by the data processing device 4, the latter automatically sends, for example by e-mail, an offer to the customer K2 to buy the patent, taking into account further particulars concerning the buying price and the buying conditions, which the administrator in the bankruptcy proceedings has additionally transmitted with the patent numbers to the data processing device 4. It does not necessarily have to be a complete offer in which all the contract conditions are already drawn up. Rather, the offer may also be just a request to the customer K2 to transmit an offer to the administrator in the bankruptcy proceedings himself or to make contact with the administrator.

After checking the patent numbers, the data processing device 4 additionally checks for the customer K2 on the basis of the patent classes transmitted by the customer K2 and also on the basis of the headwords made available by the customer K2 whether there are among the patents offered further patents which could come into consideration for the customer K2 to buy. It is possible here for more than one headword and/or patent class to be combined by means of logic operations to form a search filter which the data processing device 4 uses. Optionally, patent numbers can also be included in the search filter.

In an analogous way, the data processing device checks for the customer K3 whether there are among the patents offered patents which are allocated to patent classes of interest to the customer K3 or the subjects of which are of interest to the customer K3. If, on the basis of these criteria, the data processing device 4 identifies among the patents offered further patents of interest to the customer K2 or the customer K3, the data processing device 4 transmits to the data processing device 2 or the data processing device 3, for example by e-mail, corresponding offers to the customers K2 and K3. These offers also do not necessarily have to be offers comprising all contract conditions, but instead the offer may also be understood as being a request to the customers K2 and K3 to submit to the administrator in the bankruptcy proceedings for the company X a corresponding offer to buy the patents identified.

In this way, the data processing device 4 is consequently used to create the preconditions for quickly and effectively finding parties interested in buying patents that are for sale and at least establishing a contact between the interested buyer and the seller.

Incidentally, after identification of a potential customer or interested party, the latter does not necessarily have to be immediately sent an offer to buy or a message that a property right is for sale by the data processing device 4. Rather, it is also possible for the offering party or seller only to be notified by the data processing device of the potential interested party. In this way, the offering party is left with the possibility of deciding itself whether it wishes to approach the interested party.

The identification of the patents of interest to the customers K2 and K3 also does not necessarily have to take place by the data processing device 4 of the service provider. Rather, the data processing devices 2 and 3 of the customers K2 and K3 could alternatively also receive patents for sale, for example, from the data processing device 4 of the service provider and identify themselves patents of interest to the customer K2 or the customer K3 on the basis of one or more specified criteria. If there is a corresponding intention to buy, the customers K2 and K3 could then make contact with the company X or the administrator in the bankruptcy proceedings.

The invention has been presented above on the basis of the example of a company which has gone bankrupt and is offering patents for sale. However, the method according to the invention is suitable for initiating the sale of any property right applications or property rights. Consequently, they do not necessarily have to be patent applications or patents, but may also be other industrial property rights, for example designs, utility models or trademarks.

For the identification of a property right application of interest or a property right of interest and for the finding of potential interested parties, it is also not necessary to use both property right numbers, patent classifications and specific keywords or headwords as a criterion for the selection. Rather, just one of these criteria or some other suitable criterion may also be used for the identification. Further criteria are the title, the heading, the inventor, the applicant, the filing date, the priority date or the publication date of the property right application or the property right, insofar as such data exist for the respective property right application or for the respective property right.

1. A method of initiating a sale of a property right application or of a property right, having the following method steps:
a) reception by a data processing device (4) of a code, originating from an offering party (X), of a property right application that is for sale or of a property right that is for sale which allows a clear identification of the property right application or the property right, and
b) identification by the data processing device (4) of a property right application of interest or a property right of interest and/or finding of a party (K2, K3) potentially interested in the property right application or the property right on the basis of a criterion.

2. The method as claimed in claim 1, in which the offering party (X) is automatically notified of a found potential interested party (K2, K3).

3. The method as claimed in claim 1 or 2, in which the data processing device (4) sends a message to a potential interested party (K2, K3) that the property right application or the property right is for sale.

4. The method as claimed in one of claims 1 to 3, in which the property right application is a patent application or the property right is a patent.

5. The method as claimed in one of claims 1 to 4, in which the property right application or the property right is allocated to a class.

6. The method as claimed in claim 5, in which the class is a patent class.

7. The method as claimed in one of claims 1 to 6, in which the criterion is the fact that the property right application or the property right belongs to a class.

8. The method as claimed in one of claims 1 to 7, in which the criterion comprises at least one specific headword or a date, which is specified by the potential interested party (K2, K3).

9. The method as claimed in one of claims 1 to 8, in which the criterion is a code of a property right application or a property right, which is specified by the potential interested party (K2, K3).
